(19) United States
(12) Patent Application Publication
(10) Pub. No.: US 2005/0024228 A1
(43) Pub. Date: Feb. 3, 2005

(54) Method for matching transmitters and receiver

(76) Inventors: Bruno Vignon, Annecy (FR); Florent Pellarin, Annecy (FR)

Correspondence Address: WELSH & KATZ, LTD, 120 S RIVERSIDE PLAZA, 22ND FLOOR, CHICAGO, IL, 60606, US

(21) Appl. No.: 10/497,861

(22) PCT Filed: Dec. 17, 2002
(86) PCT No.: PCT/FR02/04388

(30) Foreign Application Priority Data
Dec. 21, 2001 (FR) 01/16709

(51) Int. Cl. G08C 19/00

(52) U.S. Cl. 340/825.72

(57) ABSTRACT

A receiver is matched with two transmitters (8, 10, 12); the receiver (4) supplies a first transmitter (8) with an address and simultaneously stores the supplied address. The first transmitter stores the address supplied by the receiver. The receiver then supplies to a second transmitter (10) an address different from the address supplied to the first transmitter; the receiver simultaneously stores the supplied address. The second transmitter stores the address supplied by the receiver. The supply of different addresses for different transmitters enables to improve security by using between each transmitter and the receiver revolving code methods.

### BACKGROUND OF THE INVENTION

The invention relates to the field of transmitters and receivers, and in particular transmitters and receivers of home automation systems.

Such systems are used for motorized products or automatic devices for closing or for solar protection in buildings or for the control of lighting or other units. Typically, one or more transmitters are provided; each device to be controlled—rolling shutter, blind, lighting unit, etc—is associated with a receiver; it is also possible for provision to be made for several devices to be controlled by a same receiver. The radio transmitters and receivers use the same transmission frequency, or predetermined frequencies. For these devices, and in particular for motorized products or automatic devices for closing or for solar protection in buildings, logistic reasons most often necessitate that the pairing is not performed during manufacture, but rather on the worksite, after installation of the products.

A first known solution consists in allocating each transmitter with its own identifier which, during a learning procedure, is directly or indirectly stored in the receiver. Thus, in U.S. Pat. No. 4,750,118, the respective identifiers of a plurality of transmitters can be recorded in a memory located in the receiver. During operational functioning, the latter validates a received command only after having observed that this command is coming from a transmitter whose identifier has been recorded previously.

Similarly, but in a more sophisticated manner, U.S. Pat. No. 6,049,289 provides for the recording in the receiver of both an identification number and a secret key, transmitted by the transmitter during a learning phase of the receiver.

In both of the cases mentioned relating to this first principle, each transmitter is therefore characterized only by a single identifier. This identifier corresponds to a factory code.

Thus, according to this first principle, during the successive pairings of the receiver with the plurality of transmitters intended to control it, a table of authorised identifiers is progressively constructed in the receiver.

Another known solution consists in allocating the receiver with a unique identifier. It is therefore this identifier that is communicated, during a learning operation to each one of the transmitters authorized to operate the equipment. Thus U.S. Pat. No. 4,529,980 discloses a system in which the identifier of the receiver is transmitted to the transmitter via an optical link. The transmitter optionally contains several memories, in order to learn as many identifiers as there are different devices to control, and therefore as there are receivers. The quoted patent describes, for example, a remote control unit having four different channels.

U.S. Pat. No. 5,148,159 provides a variant of the above method wherein the link between the receiver and the transmitter is produced by a serial transmission of the asynchronous type at the moment of each pairing.

In both cases mentioned with respect to this second principle, each receiver is therefore characterized only by one single identifier. This identifier corresponds to a factory code, or even to a code established in a random manner according to a special code allocation procedure which can be activated by the owner of the installation.

It has furthermore been proposed to change the code transmitted by a transmitter to the receiver at each transmission; in the event of a clandestine recording of the signal transmitted by radio from the transmitter to the receiver, this technique prevents the transmission of the recorded signal from being able to control the receiver. Such a solution is described in U.S. Pat. No. 6,089,289: in this document, both the transmitter and the receiver are provided with a memory containing a synchronisation value; this synchronisation value is incremented in the transmitter at each transmission of a command to the receiver. The synchronisation value is incremented in the receiver each time a command coming from the transmitter is received. A problem associated with this type of solution is that the transmitter can be actuated outside of the receiver's range such that the synchronisation values in the transmitter and the receiver differ. The solution proposed in U.S. Pat. No. 6,089,289 consists in providing in the receiver a range of acceptable synchronisation values which contains not only the expected next synchronisation value but also the next 15 expected values. In this document there is also provided a self-synchronisation procedure in the case where the transmitter is actuated out of the receiver's range more than 15 times.

### SUMMARY OF THE INVENTION

There is therefore a need for a reliable, simple and secure method of transmission of commands from a plurality of transmitters to a receiver which applies to paired transmitters and receivers.

In one embodiment, the invention therefore provides a method of pairing a receiver with at least two transmitters and comprising the steps of:
(a) the supply of an address by the receiver to a first transmitter, and storage of the supplied address by the receiver;
(b) storage of the address by the first transmitter;
(c) supply by the receiver to a second transmitter of an address different from the address supplied to the first transmitter, and storage by the receiver of the supplied address;
(d) storage by the second transmitter of the address supplied by the receiver; each transmitter being able to transmit to the receiver a command, that is a function of the stored address, the receiver executing the command only if the address of which it is a function is an address stored in the receiver.

Preferably, the supply step comprises the generation of the address by a pseudo-random generator.

It is also possible to provide for the method to comprise, for a transmitter, the modification according to a predetermined algorithm of the stored address or of a part of the latter after the sending of a command to the receiver. It is therefore preferable for the method to comprise, for the receiver, the modification according to a predetermined algorithm of the stored address, or of a part of the latter, for a transmitter after receipt of a command from that transmitter.

It is also possible to provide a step of deletion by the receiver of the address supplied to a transmitter.

In another embodiment, the invention provides a non-paired receiver, comprising command receiving means, a table containing at least two separate addresses and a circuit capable of extracting an address from a command received by the receiving means and of comparing an extracted address and the addresses in the table.

Advantageously, the receiver comprises a means of transmitting an address from the table. The table can contain, for an address, an associated rolling code value. It can also have, for an address, a field representing the transmission of that address.

Finally, the invention provides an installation comprising such a receiver and at least two transmitters.

Other characteristics and advantages of the invention will appear on reading the following description, given by way of example and with reference to the drawings.

### BRIEF DESCRIPTION OF THE DRAWINGS

FIG. 1 is a diagrammatic view of an installation according to the invention;

FIG. 2 is a block diagram of the logic structure of a receiver according to the invention;

FIG. 3 is a block diagram of the logic structure of a transmitter according to the invention;

FIG. 4 is a flowchart of a method used in the receiver;

FIG. 5 is a flowchart of the method used in the transmitter.

### DETAILED DESCRIPTION OF PREFERRED EMBODIMENTS

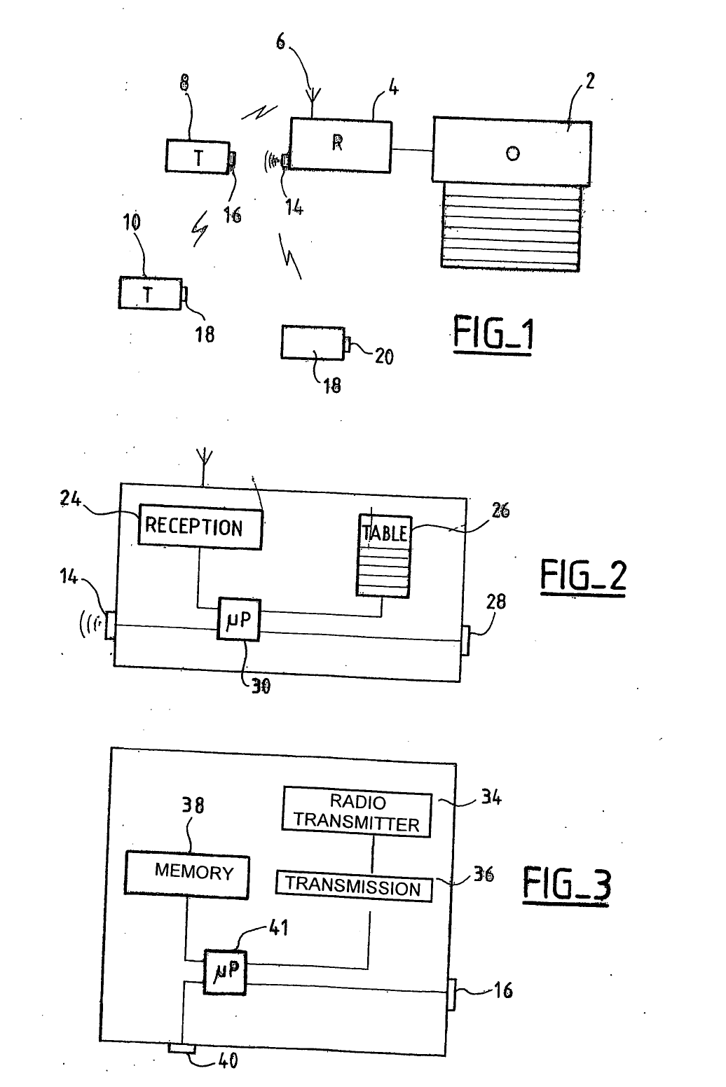

FIG. 1 is a diagrammatic view of an installation in a first example embodiment of the invention. The installation comprises an operating unit 2, referenced by the letter “O” in the figure. This operating unit can, for example, roll up or unroll blinds, rolling shutters or a garage door, actuate a lighting unit, open a door, start or stop an alarm, etc. The operating unit is connected to a receiver, referenced by the letter “R” in the figure. The receiver has an antenna 6 which allows it to receive commands transmitted by radio link from a transmitter. The radio transmission of commands from a transmitter to a receiver is known per se and is not described in greater detail here. FIG. 1 also shows a plurality of transmitters 8, 10, 12. Each transmitter is designed to transmit one or more commands by radio to the receiver 4 and, for this purpose, has an antenna which is not shown. Typically, a transmitter, in the case of controlling a rolling shutter, can transmit commands to raise, lower or stop the shutter; other commands can be provided, such as the placing of the shutter in pre-programmed positions, shutter programming commands, etc. The transmitter therefore has one or more devices allowing the user to enter a command; in the simplest case these can be one or more control buttons.

Furthermore, the receiver is designed to also transmit signals to the transmitters; as explained below, the transmission of signals from the receiver to the transmitter allows the pairing of the transmitters with the receiver. Because of this, this transmission is not used during the normal functioning of the installation and can have functional characteristics—transmission range, transmission capacity, etc.—that are lower than for the transmission in the direction from the transmitter to the receiver. It is possible to provide various transmission channels from the receiver to a transmitter; radio is used in a simple configuration, the transmitter and the receiver then constituting a “transceiver”, that is to say a transmitter-receiver; this solution has the advantage of simplicity, but is rather costly. It is possible to provide transmission via an optical channel by providing the receiver with an infrared diode 14 and a transmitter 8, 10 or 12 with a corresponding sensor 16, 18, 20; it is also possible to provide transmission by electrical signals by providing the receiver and the transmitter with contacts that can be connected to each other. Whichever system is used, the receiver can transmit signals and programming commands to the transmitter.

The problem of the invention is to pair the transmitter or transmitters with the receiver, in other words to ensure that the commands transmitted by certain transmitters make it possible to actuate the operating unit by the intermediary of the receiver—whilst the transmission of commands by other transmitters has no effect.

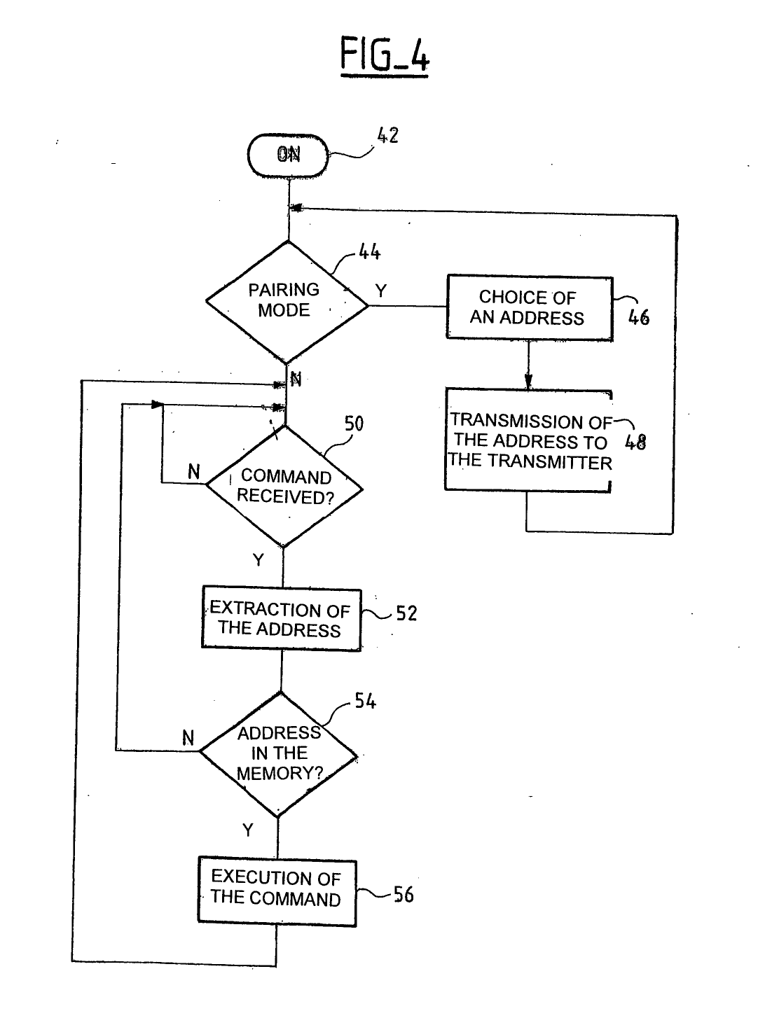

For this purpose, the invention provides that the receiver supplies each of the transmitters that must be paired with it with an identifier that is unique to the transmitter. This identifier is furthermore stored by the receiver. This identifier is subsequently used by the transmitter to identify the commands transmitted to the receiver; the receiver can thus determine the origin of the commands that it receives and execute a command only if it comes from a transmitter that is paired with it. The method is described in greater detail below with reference to FIG. 4.

As the receiver contains an identifier for each of the transmitters, it is possible to implement, independently for each of the identifiers, protection methods of the rolling code or other type. The invention therefore overcomes the disadvantage of the devices described in U.S. Pat. No. 4,529,980 or U.S. Pat. No. 5,148,159, which cannot support the so-called rolling code transmission security means.

For purposes of simplification, the register of the transmitter containing the rolling code to be used for the next transmission is denoted by “RCT” and the register of the receiver containing the expected value for the next rolling code is denoted by “RCR”. In the case of a plurality of authorized transmitters, even if the rate of use is not the same from one user to another, each transmitter will have its register RCT evolving in way that is independent from the other transmitters: the receiver is capable of identifying each transmitter Ti and can therefore, independently from the other transmitters, update the register RCRi corresponding to that transmitter. The use of different identifiers or addresses for each transmitter therefore makes it possible to implement security by rolling code, even if the respective rates of use of the transmitters are different.

The invention therefore makes it possible for remote control systems according to the second principle to have at least the same level of security as the systems according to the first principle.

Furthermore, the presence of an identifier for each transmitter allows simple and reliable management of the different transmitters; in the case of loss or theft of a transmitter, it suffices to delete the identifier allocated to the lost or stolen transmitter from the receiver's memory for the command transmitted by that transmitter to be no longer considered by the receiver as a valid command.

FIG. 2 is a block diagram of the logic structure of a receiver according to the invention; as explained above, the receiver 4 has an antenna 6 and is connected to an operating unit 2. The receiver comprises a reception stage 24 which, in the proposed example, is a radio-frequency reception stage receiving the signals picked up by the antenna 6. It also has a means of transmission, in this example an infrared diode 14; as mentioned above, the transmission means allows a communication, preferably short-range, to the transmitter and which is used, in particular, during a phase of pairing the transmitter with the receiver 4.

The receiver 4 also contains a table or memory 26 containing the valid addresses for the control of the receiver. The receiver also contains a hardware or software device 28 for switching to the pairing or learning mode. When this device is activated, the receiver 4 switches into pairing mode. When it ceases to be activated, the module returns to the operational mode. The device 28 is for example a button present on the receiver, as shown in the figure, or it can be sensitive to a momentary break in the electrical power supply of the receiver. The device 28 can also be sensitive to a particular command received by the antenna 6.

The operation of the different components of the receiver is controlled by a microprocessor 30 or by any other means carrying out such functions.

When it is in the pairing mode, the receiver 4 transmits, using the transmission means 14, the content of an address in the table that has not already been transmitted. This transmission can be managed according to any protocol adapted to the transmission channel used from the receiver to the transmitter. Thus, on an infrared or optical link, it is possible to use a serial transmission protocol. It is also possible to use a transmission protocol of the trial-and-error type: the transmitter to be paired transmits sequences of n bits (for example four bits). Each time a configuration corresponds to n specific bits of the address to be transmitted, the receiver 4 transmits a simple signal. The transmitter, which receives this signal, records the current configuration and reiterates the process, knowing that is it now relating to the following n bits of the address. The algorithms of the transmitter and of the receiver 4 are of course based on the same rule for breaking down and scanning the address in packets of n bits. This solution limits the transmission from the receiver to the transmitter and can, in certain cases, be more advantageous by simplifying the link in the receiver to transmitter direction.

In normal operational mode, the receiver 4 receives, via the antenna 6, signals coming from transmitters. A transmitter intended to control the actuator controlled by the receiver 4 accompanies the address transmission frame which has been transmitted to it by the receiver during the pairing phase. After reception, the receiver 4 checks that it is an address contained in the table 26; if this is the case, the receiver decodes the rest of the frame and consequently controls the operating unit.

FIG. 3 is a block diagram of the logic structure of a transmitter according to the invention. The transmitter 8 itself contains a remote transmitter 34, for example a radio transmitter, with the associated transmission stage 36; it also contains, as explained above, a means of reception 16 designed to receive the signal transmitted by the receiver 4, preferably by a short-range link.

The transmitter also contains at least one memory location 38 allowing it to store in a durable manner the address that is transmitted to it by the receiver 4 in the pairing phase, this being the address that it is authorized to use for communications with this receiver.

The transmitter also contains a hardware or software device allowing it to switch into pairing mode. It can be a button 40, as shown in the figure; it is also possible to program the transmitter such that is switches into pairing mode on receipt of a pairing command from the receiver 4; it is also possible to program a sequence of keys that is not very probable in normal operation, which causes the transmitter to switch into the pairing mode. In this pairing mode, the reception means 16 is activated, and the data received from the receiver 4 is stored in the durable memory 38. As for the receiver, a microprocessor 41 or any other computing circuit which controls the functioning of the various components of the transmitter is provided.

FIG. 4 is a flowchart of a method used in the receiver; step 42 represents the switching on of the receiver; in the first step 44, a test is performed to see if the receiver is in pairing mode; if this is the case, the process moves on to step 46 and an address to be transmitted to the transmitter is chosen. As explained below, this step can, in the simplest embodiment, consist of choosing an address from the table; it is also possible to generate the address and to store it in the table. In the next step 48, the chosen address is transmitted to the transmitter; this step can of course differ depending on the protocol used. The process then returns to step 44.

In step 44, if the receiver is not in pairing mode, the process moves on to step 50 in which the receiver waits for a command. When a command is received, the process moves on to step 52, in which the command is analysed, if necessary with decoding, in order to extract the address included in the command by the transmitter.

In step 54, the address used by the receiver is compared with the addresses stored in the memory 26 of the receiver. If the address is not a valid address, the process returns again to step 50, waiting for a command, or to step 44. On the other hand, if the address corresponds to an address stored in the memory 26 of the receiver, the process moves to step 56; in this step the received command is executed by transmitting the instruction corresponding to the command to the operating unit. The process then moves to step 50, or to step 44. The choice of one or other of these steps depends on the way in which the switching to pairing mode is controlled—in particular if this switching to pairing mode can interrupt the operational functioning; in the example, it is implicitly assumed that it is possible to enter the pairing mode only after the switching on of the device. The process therefore moves to step 50 after step 54 or 56.

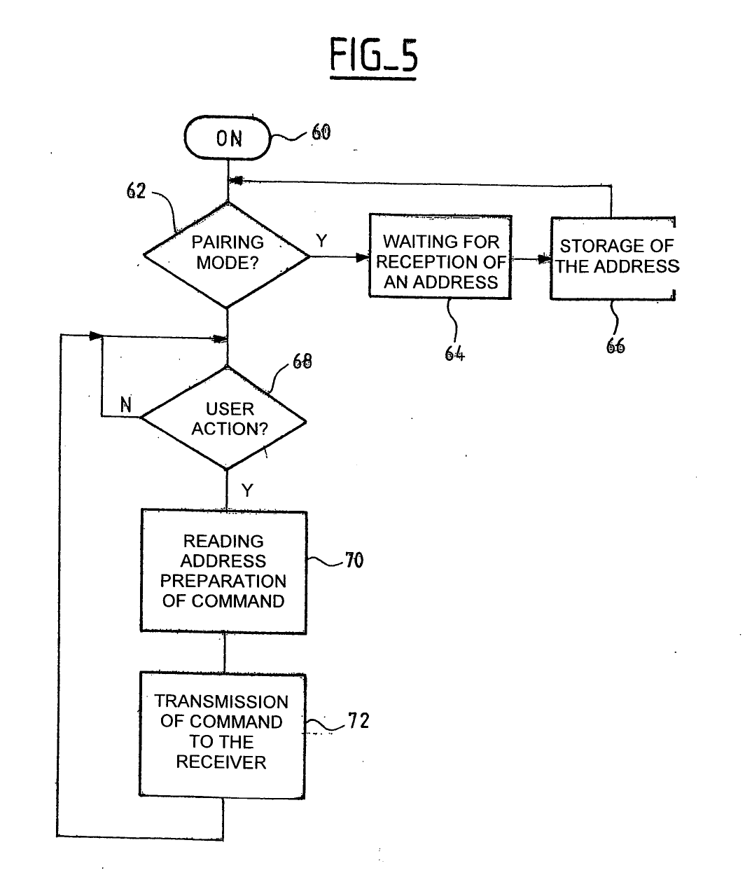

FIG. 5 is a flowchart of the method used in the transmitter. Step 60 represents the switching on of the receiver; in the first step 62, a test is preformed to see if the receiver is in pairing mode; if this is the case, the process moves to step 64 and waits for the receiver to transmit an address. In the next step 66, the received address is stored in the memory 38. The process then returns to step 62.

In step 62, if the transmitter is not in pairing mode, the process moves to step 68, in which the transmitter is waiting for an actuation by the user. When the user presses the button or one of the buttons of the transmitter, the process moves to step 70, in which the address is read from the memory and a command including the address is prepared. In step 72, the prepared command is transmitted to the receiver. The process then moves to step 68, waiting for a command, or to step 62. As above, the choice of one or other of these steps depends on the way in which the switching into pairing mode is controlled—in particular if this switching into pairing mode can interrupt the operational functioning.

The operational mode described above can be the subject of many variants. As each transmitter can have a unique address allocated to it by a receiver during the pairing phase, it is possible to make the installation secure using a rolling code method. In this case, the table 26 of the receiver contains, for a transmitter, at least two fields:
an address field containing a fixed identifier transmitted to the transmitter during the pairing phase and then accepted by the receiver as the address for that transmitter;
a field CR containing an initial rolling code value.

The initial value of the rolling code is also transmitted to the transmitter during a pairing procedure; it can then be incremented each time the said transmitter is operated, according to means of rolling code management known to a person skilled in the art. In other words, in the transmitter the address or the value of the rolling code—which can be considered as a part of a generalised address—can be modified according to a predetermined algorithm after the sending of a command; similarly, in the receiver the address or the rolling code value corresponding to a transmitter can be modified according to a predetermined algorithm after reception of a valid command from that transmitter.

It is also possible to provide a third validation field in the table, for example a single bit field. This field can on the one hand be used for indicating that the corresponding address has been the subject of a pairing operation and therefore that it must be recognized as valid. In pairing mode, this field makes it possible to scan the table rapidly in order to find an address for a transmitter to be paired; in operational mode, the field makes it possible to scan the table rapidly in order to read the addresses recognized as being valid and to compare them with a received address.

The content of the table 26—or at least of the address and rolling code fields—can be fixed in the factory. It is also possible to make provision for this content to be modifiable using a hardware or software module allowing the generation of pseudo-random numbers in the table. A hardware solution can consist in using traditional contacts of “DIP-switches” type; a software solution consists in using a pseudo-random number generator.

This solution provides an important benefit in terms of independence of the owner of the installation with respect to the hardware manufacturer. It is then possible for the owner of the installation himself to define a set of codes which has not been fixed in advance by the manufacturer or by the installer. This solution is also particularly advantageous in operation according to the second principle: only the receiver contains the hardware or software module allowing the generation of numbers; the transmitters do not need to contain this module. Conversely, a generation of numbers in an installation according to the first principle necessitates providing each transmitter with a module, for example of the DIP-switches type.

Therefore, by using the second principle and such a module, the following drawbacks are avoided:
nothing is less obvious than generating a truly random number by calculation: simple algorithms are often biased by the physical characteristics of the components that will preferably choose to switch to a “1” state rather than a “0” state, or vice-versa. There are algorithms making it possible to generate binary sequences that are pseudo-random to a high degree, but the fact of installing such an algorithm in each one of the transmitters represents a costly increase in computing power and in the memory size in each transmitter, whereas the latter are portable and necessitate the highest degree of miniaturization or the lowest consumption and the lowest cost; conversely, the receiver already has a large memory capacity and a larger computing power and is not subject to consumption restrictions; is can more easily receive such an algorithm;
in the case in which each transmitter according to the first principle would have the ability to modify the identifier in a random manner, the problem arises in that it is possible for two transmitters of the same installation to take the same identifier at the time of configuration. If this occurs, in the case of rolling code, the problem already mentioned arises again in that the receiver will be incapable of following the RC assigned to each transmitter: one of them will be rejected by the receiver.

In this embodiment combining the second principle and a generation of numbers, the invention therefore makes it possible to provide a higher level of security and reliability than in the prior art by simultaneously combining: the advantages of the rolling code and the advantages of random configuration at the owner's initiative, this being in a multi-transmitter configuration.

The module can be activated automatically when the receiver is first switched on, or it can be used during each pairing operation in order to generate a new address. This module can be activated by means of a specific button, or of a particular control code transmitted by a particular transmitter. If the entire table is regenerated, it is essential to carry out a new pairing of the transmitters in order to provide them with valid addresses. In the case of such a module, it is appropriate that the algorithm used should guarantee that two identical values in the table are impossible, unless it is accepted that two transmitters receive the same address.

As a variant, it is possible that the modification applies only to a particular position in the table, corresponding for example to a transmitter indicated as being lost or stolen. In this case, the receiver 4 can be provided with means—keyboard, display or other means—making it possible to locate a particular zone in the address table. This variant makes it possible in particular, in the case of loss or theft of a transmitter, simply to delete the corresponding address in the address table; it thus becomes impossible to use the transmitter for controlling the receiver. The corresponding line in the table can then be used for another transmitter.

The invention also provides another operational mode which considerably simplifies the architecture of the receiver 4. In this embodiment, the activation of the pairing means 28 of the receiver systematically causes the generation of a random value replacing in the table the value would normally have been sent to the transmitter, or adding a new randomly generated number to the table. This embodiment has the advantage of security—since a new random value is generated for each new paired transmitter; it thus has the advantage of simplicity; it is not necessary to provide a hardware or software command to activate the pseudo-random numbers generating module.

As is known in the prior art, and as the assignee produces in the radio remote control products marketed under the RTS label, the command to switch to learning or pairing mode can come from a transmitter already having a means of identification by the receiver 4 as it is already previously paired. External access to the pairing means 28 is not therefore essential provided that an already paired transmitter is available. In order to pair a new transmitter, it suffices to use a transmitter that is already paired, on the basis of which the next pairing will be carried out.

This embodiment can be combined with the preceding ones, as shown by the following example. Let it be assumed that the transmitter T3 of an installation comprising four transmitters has disappeared. Using its transmitter T2 for example, the owner generates a combination of keys which makes it possible to inform the receiver 4 that the “pairing by replacement” mode must be activated. In this pairing mode, the table is not scanned until an address not yet used is found, but the rank of the address to be replaced in sent by the owner to the receiver 4 using a transmitter; it is preferably possible to use the already authenticated one, or the one that is to be paired. For example, it is possible to transmit to the receiver the rank of the address to be replaced in the form of a succession of key pressings, the number of pressings indicating the rank.

It is also possible to use a reaction of the owner, by means of his transmitter, to the signal transmitted by the receiver 4 using an indicator lamp or even using the actuator controlled by the operating unit. Thus the receiver 4, which can contain four valid addresses will successively flash an indicator lamp once, then twice, three times and four times, each time leaving a time interval (for example of 3 seconds) sufficient to allow the owner to validate the choice, for example by reiterating the pairing command. This validation will therefore be carried out in the chosen example when there is a triple flashing, or when there is a triple movement of the actuator.

The address contained in the table and previously corresponding to the transmitter T3 in the example is then deleted. The corresponding line in the table is used for storing a new address, which is transmitted to a new transmitter during a pairing phase; for this purpose it is possible to use a randomly generated address, as explained above.

In all cases, the addresses can have a common part and a variable part, whether it is generated randomly or not. The common part can for example be a function of the serial number of the receiver, the family code of the receiver, the transmission mode used, or something else. This embodiment makes it possible to provide the transmitter, during the pairing phase, with information on the receiver. Furthermore, this embodiment can make it possible to limit the risk of two receivers supplying the same address to different transmitters. It is therefore possible to use identical transmitters for different types of receivers, the address informing the transmitter which type of receiver it is sending a command to; this embodiment is particularly advantageous for universal transmitters, or for transmitters having several memories and able to send commands to several different receivers. The transmitter can also in this case adapt the meaning of the keys according to the receiver.

The invention is not of course limited to the embodiments described above. Thus, in the examples, the case considered was where there was one receiver and a plurality of transmitters; but the invention also applies to several receivers and several transmitters, each receiver communicating an address or identifier to each transmitter during the pairing phase. In the different embodiments, the addresses transmitted to each transmitter by a receiver are different; this allows increased security in particular, as mentioned above; even though this is not considered as advantageous, it is however also possible to allow a receiver to transmit a same address to two different transmitters: there would then be two undifferentiated transmitters among the various transmitters paired with the receiver.

The transmission methods used between a transmitter and a receiver are given only by way of example and can be modified. The invention applies, in particular, whether the transmitters and receivers use a single frequency or whether each one transmits on a separate frequency, or in frequency steps or with different modulations. In fact, the method applies since the receiver supplies the transmitters with an address allowing them to be identified—irrespective of the manner in which this identification is carried out.

The words “receivers” and “operating units” have been used, which apply in particular to the example of rolling shutter operating units. The receiver and the operating unit can be separate elements, as in the examples, or can form a single assembly.

In the examples, the transmitters send their address to the receiver during the transmission of a command; it is obviously possible to encode or encrypt the corresponding address using techniques known in the prior art.

1-10. (cancelled)

11. A method of pairing a receiver with at least two transmitters, comprising the steps of:
a) the supply of an address by the receiver to a first transmitter, and storage of the supplied address by the receiver;
b) storage of the address by the first transmitter;
c) supply by the receiver to a second transmitter of an address different from the address supplied to the first transmitter, and storage by the receiver of the supplied address; and
d) storage by the second transmitter of the address supplied by the receiver; each transmitter being able to transmit to the receiver a command, that is a function of the stored address, the receiver executing the command only if the address of which it is a function is an address stored in the receiver.

12. The method according to claim 11, wherein the supply step comprises the generation of the address by a pseudo-random generator.

13. The method according to claim 11, comprising for a transmitter, the modification according to a predetermined algorithm of the stored address or of a part of the latter after the sending of a command to the receiver.

14. The method according to claim 12, comprising for a transmitter, the modification according to a predetermined algorithm of the stored address or of a part of the latter after the sending of a command to the receiver.

15. The method according to claim 11 further comprising, for the receiver, the modification according to a predetermined algorithm of the stored address, or of a part of the latter, for a transmitter after receipt of a command from that transmitter.

16. The method according to claim 11, wherein it comprises a step of deletion by the receiver of the address supplied to a transmitter.

17. A non-paired receiver, comprising command receiving means, a table containing at least two separate addresses and a circuit capable of extracting an address from a command received by the receiving means and of comparing an extracted address with the addresses in the table.

18. The receiver according to claim 17, wherein it comprises a means of transmitting an address from the table.

19. The receiver according to claim 17, wherein the table contains, for an address, an associated rolling code value.

20. The receiver according to claim 18, wherein the table contains, for an address, an associated rolling code value.

21. The receiver according to claim 20 wherein the table contains, for an address, a field representing the transmission of that address.

22. An installation comprising
a non-paired receiver, comprising command receiving means, a table containing at least two separate addresses and a circuit capable of extracting an address from a command received by the receiving means and of comparing an extracted address with the addresses in the table, and
at least two transmitters.
